(19) United States
(12) Patent Application Publication
(10) Pub. No.: US 2021/0355664 A1
(43) Pub. Date: Nov. 18, 2021

(54) EYE WASH STATION INSPECTION GUARD

(71) Applicant: Merck Sharp & Dohme Corp., Rahway, NJ (US)

(72) Inventor: Brian C. Magliaro, Warrington, PA (US)

(73) Assignee: Merck Sharp & Dohme Corp., Rahway, NJ (US)

(21) Appl. No.: 17/317,993

(22) Filed: May 12, 2021

Related U.S. Application Data
(60) Provisional application No. 63/025,398, filed on May 15, 2020.

(51) Int. Cl. E03C 1/181

(52) U.S. Cl. CPC E03C 1/181; A61H 35/02

(57) ABSTRACT

As a part of routine maintenance and testing, one must ensure that eye wash stations have access to clean water that flows appropriately and at the proper water pressure. Testing appropriate water flow and water pressure is messy. The inspection splash guards of the instant invention minimize water from splashing outside a wash basin area and are transparent to ensure proper visualization during eye wash station maintenance and testing.

### FIELD OF THE INVENTION

The present invention described herein relates to eye wash station inspection splash guards.

### BACKGROUND OF THE INVENTION

The Occupational Safety and Health Administration (OSHA) regulations provide that, for individuals working under conditions where exposure to injurious, hazardous and/or corrosive materials may occur (e.g., laboratory settings in academia and industry), suitable facilities for quick drenching or flushing of the eyes shall be provided within the work area for immediate emergency use. As such, eye wash stations are ubiquitous and of critical importance and care must be taken to ensure that eye wash stations are properly functioning necessitating routine maintenance and testing.

As a part of routine maintenance and testing of eye wash stations, one must ensure access to clean water that flows appropriately and at the appropriate pressure. Testing appropriate water flow and water pressure is messy. The instant invention provides improved eye wash station inspection guards to facilitate the testing process.

### SUMMARY OF THE INVENTION

The present invention relates to inspection eye wash station splash guards that minimize water from splashing outside the basin area, are transparent to ensure proper visualization during eye wash station maintenance and testing, and are lightweight, portable and easy to transport from station to station.

Eye wash stations come in many different shapes and sizes. While eye wash stations differ, they comprise two standard features. One feature is a wash basin, or a “basin” or “sink,” and the other feature is an eye wash unit. The wash basin is a receptacle, typically on a table or laboratory bench where water is collected and drained or stored. Wash basins related to the instant invention are fixed within a table or laboratory bench and attached to a plumbing system accessing and removing water, see example FIG. 1.

The eye wash unit is an apparatus that receives and directs water into two outward streams once an eye wash station user engages or turns on water flow from a fixed plumbing system. The two streams are appropriately configured to direct water upward towards the eyes of the eye wash station user. The eye wash unit can be made of any material as long as it is rigid enough to support water flow into, through and out of the eye wash unit. Eye wash units related to the instant invention are part of an eye wash station that is fixed, for example connected to a faucet, see example FIG. 2.

The present invention described herein relates to eye wash station inspection splash guards that help to minimize water splashing during the inspection process and direct water into a wash basin. The eye wash station inspection guards of the instant invention are transparent allowing an eye wash station inspection user to easily maintain and test the performance of the eye wash station.

The splash guard apparatus of the instant invention comprises movable or fixed stands attached to a transparent shroud.

The stands, of which there are at least two, are of sufficient height and can be adjustable to allow the shroud to rest flush and balanced on a table or the eye wash unit, providing stability to the splash guard apparatus when in use and proper funneling of water into the wash basin. The stands may be made of any material, as long as the stands are rigid enough to support the shroud. In an embodiment, the stands are made of light weight material for ease in transportation. In another embodiment, the stands are fixed to the shroud but remain moveable. For example, the stands may be coupled to the shroud via a hinged or fastened system to allow the stands to fold under the shroud when in storage but, when in use, are unfolded and locked into position. The stands may be adjustable or telescoping. In another embodiment, the stands may have a wider or weighted base or foot to improve stability.

The shroud is transparent and can be of any dimension as long as it functions to minimize splashing (out of the table/basin area) and direct or funnel water into the wash basin. In an embodiment, the shroud is a dome shape. In another embodiment, the shroud is in a box or cube shape. In another embodiment, the shroud is designed to be collapsible for convenient storage purposes. In another embodiment, the shroud is made of a transparent plastic material.

In another embodiment, the shroud has a handle, either fixed or collapsible, for ease of carrying. In another embodiment, the shroud includes a fixed internal divider, which may be made of the same transparent plastic material as the shroud, and which separates the flow of water from a left eye spout and a right eye spout of the eye wash unit, thus enabling clear visualization of the water flow from each individual spout and preventing the flow from one spout to topple onto the other spout. In another embodiment, the shroud may contain a notch to fit over the eye wash unit and rest balanced and/or flush on the table/basin area.

To complete an inspection according to regulatory standards, water should flow through the eye wash unit for a particular length of time. In an embodiment, the shroud includes an indentation, nest, clip, or other apparatus/method to attach a lab timer to track time.

In another embodiment, as eye wash units can be at different heights and in different locations relative to the front edge of the basin, the shroud includes an additional flexible flap attached to the bottom edge of the shroud to channel water back into the basin in the event the rigid lip of the shroud hangs over the outer front edge of the basin due to the location of the eye wash unit.

### BRIEF DESCRIPTION OF THE DRAWINGS

The detailed description of some embodiments of the invention will be made below with reference to the accompanying figures, wherein the figures disclose one or more embodiments of the present invention.

FIG. 1 depicts a view of a lab table or bench (the eye wash station) containing an eye wash basin (cross section) and an eye wash unit;

FIG. 2 depicts a perspective view of the splash guard apparatus covering the eye wash unit with stands resting at the bottom of the wash basin;

FIG. 3 depicts a perspective view of certain embodiments of the splash guard apparatus; and

FIG. 4 depicts a perspective view of certain embodiments of the splash guard apparatus including additional stand features.

### DETAILED DESCRIPTION OF THE INVENTION

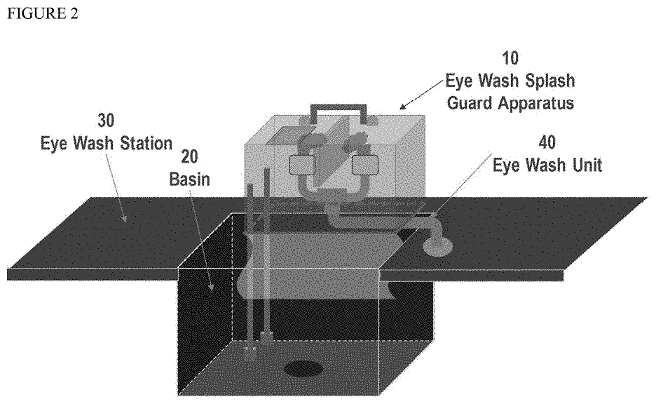

As depicted in FIGS. 2-4, the splash guard apparatus is configured to minimize or eliminate splashing when an eye wash station is under inspection. The splash guard apparatus is intended to be lightweight for storage and transport purposes. Further, the splash guard apparatus is intended to be easily set up in the wash basin/table area to allow for easy and quick inspection without the mess of splashing water.

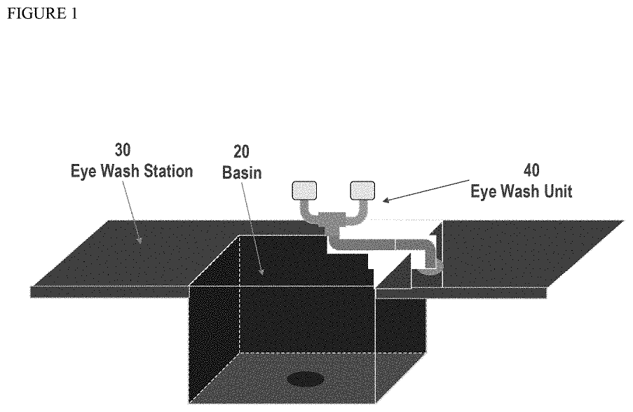

FIGS. 1-2 depict a wash basin 20, an eye wash station 30 and an eye wash unit 40.

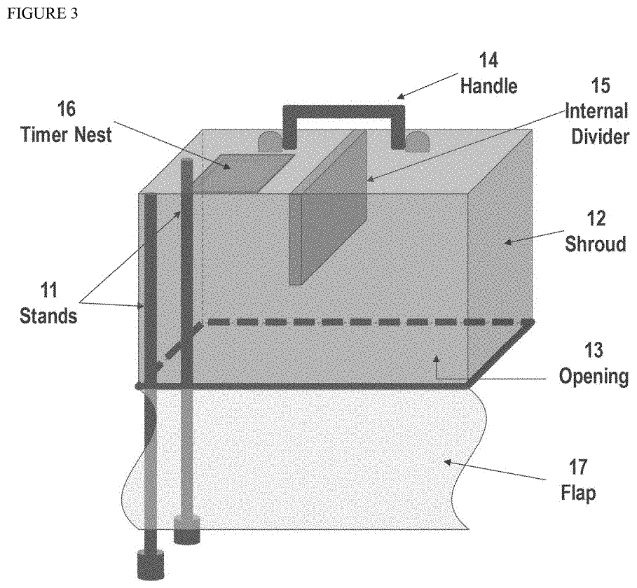

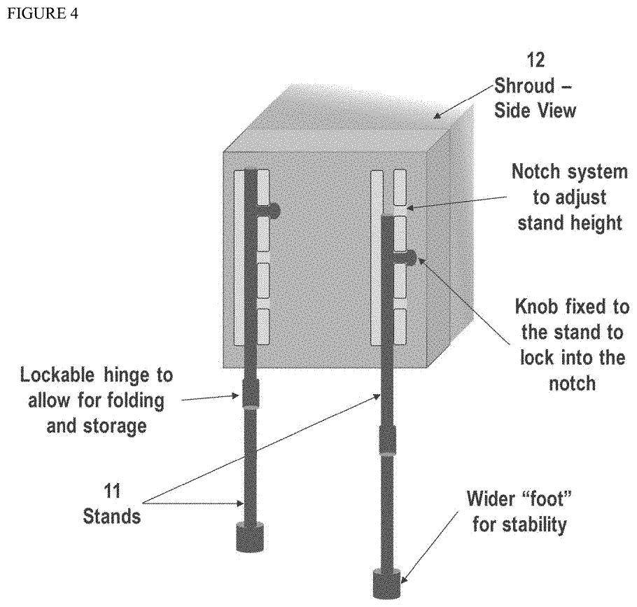

In certain embodiments of the invention, the splash guard apparatus 10 generally comprises stands 11 coupled to a shroud 12, wherein the shroud has an opening 13 wherein the opening allows an inspector to operate the eyewash unit 40. As depicted in FIGS. 3-4 the stands 11 are manufactured together with shroud 12, i.e. as one material, or constructed from one mold, and are therefore immovable or the stands 11 are manufactured apart from the shroud 12 and are therefore moveable or immovable depending on coupling method, i.e. with screws or fasteners, or other coupling methods, etc. The stands 11 can be any size and length. In a preferred embodiment the stands 11 are of a length such that, when placed in a wash basin, the shroud 12 rests on the table and the shroud 12 is relatively horizontal with the table surface. Also depicted in FIGS. 3-4 are a handle 14, an internal divider 15, an indentation or nest 16 to house the timer, and a flexible flap 17 that hangs off of the front of the apparatus to channel water into the basin.

It shall be appreciated that the components of the splash guard apparatus described in the several embodiments herein may comprise any alternative known materials in the field and may be of any color, size and/or dimensions. It shall be appreciated that the components of the splash guard apparatus described herein may be manufactured and assembled using any known techniques in the field.

Persons of ordinary skill in the art may appreciate that numerous design configurations may be possible to enjoy the functional benefits of the invention systems. Thus, given the wide variety of configurations and arrangements of the embodiments of the present invention, the scope of the invention is reflected by the breadth of the claims below rather than narrowed by the embodiments described above.

What is claimed is:

1. A splash guard apparatus comprising two or more stands coupled to a shroud.
